(19) United States
(12) Patent Application Publication
(10) Pub. No.: US 2013/0170045 A1
(43) Pub. Date: Jul. 4, 2013

(54) LIGHT-GUIDING OPTICAL FILM, AND METHOD AND DEVICE FOR MANUFACTURING THE SAME

(71) Applicant: CHIA-LING HSU, New Taipei (TW)

(72) Inventor: CHIA-LING HSU, New Taipei (TW)

(21) Appl. No.: 13/680,354

(22) Filed: Nov. 19, 2012

(30) Foreign Application Priority Data
Dec. 29, 2011 (TW) 100149525

(51) Int. Cl. B29D 11/00; G02B 5/02

(52) U.S. Cl. CPC B29D 11/0073; G02B 5/02
USPC 359/599; 425/363; 264/1.6

(57) ABSTRACT

An optical film includes a base plate. The base plate includes a first surface and a second surface opposite to first surface. The first surface includes a plurality of bar-type protrusions arranged parallel to each other. Each of the plurality of bar-type protrusions includes an arcuate surface and a planar surface connected to the arcuate surface. The planar surface intersects with the first surface. The second surface includes a plurality of posts. The present disclosure further provides a device for manufacturing the optical film and a method for manufacturing the optical film.

### BACKGROUND

1. Technical Field

The present disclosure relates to optical films, particularly to a light-guiding optical film, a device for manufacturing the optical film, and a method for manufacturing the light-guiding optical film.

2. Description of Related Art

Environmental awareness has greatly improved. People are now more aware of such things as saving energy and reducing carbon emission, and are now effectively utilizing solar energy and decreasing the use of artificial light sources. To maximize the utilization of the solar energy, products for increasing the capability of guiding the sunlight to a room, such as a light-guiding window, a light-reversing guide plate, and a light-guiding glass, for example, are increasingly employed. However, when these products are used, the original windows should be replaced by the light-guiding window, which is inconvenient and time consuming.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an embodiment of an optical film manufactured by a device.

FIG. 2 is an isometric view of the device for manufacturing optical film shown in FIG. 1, the optical film manufacturing device including a first roll and a second roll.

FIG. 3 is a flow chart of manufacturing the first roll shown in FIG. 2.

FIG. 4 is a flow chart of manufacturing the second roll shown in FIG. 2.

FIG. 5 is a flow chart of manufacturing the optical film shown in FIG. 1.

### DETAILED DESCRIPTION

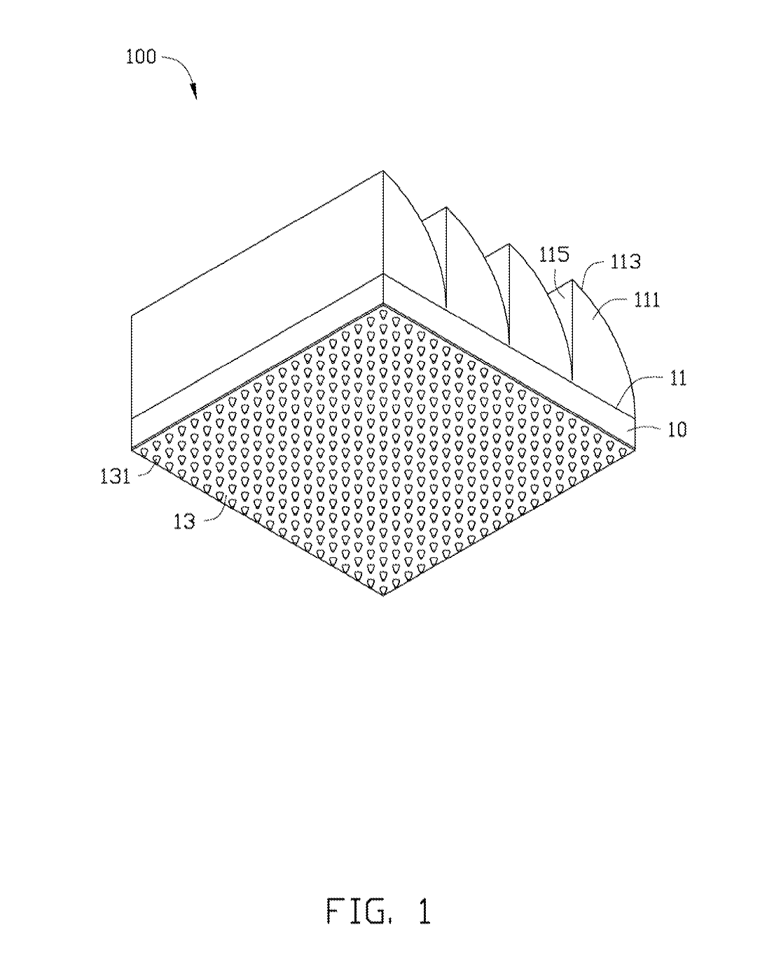

FIG. 1 shows an embodiment of an optical film 100 made of high polymer materials capable of guiding light. The optical film 100 includes a base plate 10. The base plate 10 includes a first surface 11 and a second surface 13 opposite to the first surface 11. The first surface 11 forms a plurality of bar-type protrusions 111 arranged parallel to each other. Each bar-type protrusion 111 includes an arcuate surface 113 and a planar surface 115 connected to the arcuate surface 113. A curvature of the arcuate surface 113 decides a reflection angle of an incident light to the optical film 100. In one embodiment, the bar-type protrusions 111 are arranged side by side, and each planar surface 115 is perpendicular to the second surface 13. The arcuate surface 113 is substantially a part of a sidewall of a cylinder. In other embodiments, the planar surface 115 may intersect with the first surface 11 at an acute angle or an obtuse angle. In one embodiment, the planar surface 115 intersects with the first surface 11 at an angle of 60 degrees.

The second surface 13 forms a plurality of nanometer sized conical protrusions 131. In one embodiment, the conical protrusions 131 are arranged in a matrix of rows and columns. In one embodiment, the second surface 13 has been modified to form a hydrophobic layer (not shown) having hydrophobic groups by plasma sputtering deposition. A target material of carbon tetrafluoride (CF4) or perfluoromethylcyclohexane (PFMCH), for example, is used in the plasma sputtering deposition for forming the hydrophobic layer. Thus the second surface 13 have hydrophobic characteristics. Because a thickness of the hydrophobic layer is very thin (about thousands angstroms to hundreds angstroms), it does not affect characteristics of the second surface 13. In one embodiment, the optical film 100 is made of polyethylene terephthalate (PET). A target material of carbon tetrafluoride (CF4) is used for plasma sputtering deposition to form the hydrophobic layer. In other embodiments, the optical film 100 can be made of other materials, such as silica gel, polymethyl methacrylate (PMMA), for example, and the target material for sputtering is changed correspondingly.

If the optical film 100 is pasted on a glass window of a room (not shown), the first surface 11 is adjacent to the room. In this embodiment, an intersection plane of the planar surface 115 with the first surface 11 parallel to the horizontal line can achieve light-guiding optimization. If the intersection of the planar surface 115 with the first surface 11 inclines relative to the horizontal, part of the incident light is reflected by the planar surface 115 to outside. The planar surface 115 perpendicular to the first surface 11, enables the planar surface 115 not to reflect incident light. Instead, the arcuate surface 113 reflects all of the incident light to the room. If the planar surface 115 intersects with the first surface 11 at an acute angle, the planar surface 115 will reflect part of the incident light outside, and the arcuate surface 113 will reflect the other part of the incident light to the room. Light-guiding is worse if using the optimization structure having the planar surface 115 perpendicular to the first surface 11. If the planar surface 115 intersects with the first surface 11 at an obtuse angle, the arcuate surface 113 will reflect a part of the incident light to a planar surface 115 of an adjacent bar-type protrusion 111, and the reflected light further reflected by the planar surface 115 outside. The light-guiding is not at maximum efficiency.

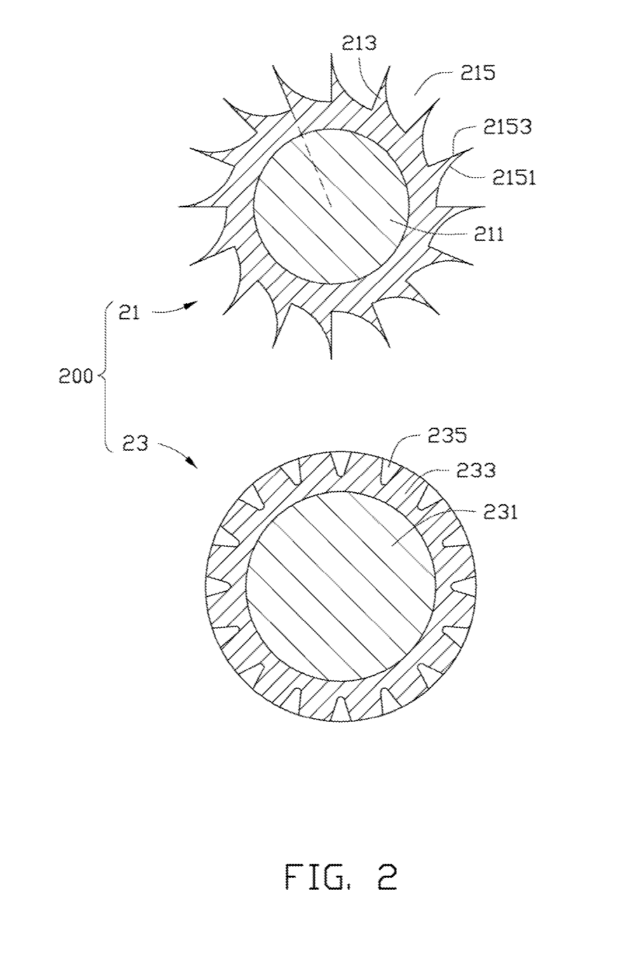

FIG. 2 shows a device 200 for manufacturing the optical film 100. The device 200 includes a first roll 21 for manufacturing the first surface 11, and a second roll 23 for manufacturing the second surface 13.

The first roll 21 includes a main body 211 and a first resin layer 213 coated on a sidewall of the main body 211. The main body 211 is substantially cylindrical, and is made of metallic materials, such as stainless steel, for example. The first resin layer 213 is made of polymerization resins including fluorine, and defines a plurality of bar-type grooves 215 matching to the shape of the bar-type protrusions 111. Each bar-type groove 215 includes an inner arcuate surface 2151 and an inner planar surface 2153 connected to the inner arcuate surface 2151. The inner arcuate surface 2151 matches the arcuate surface 113. The inner planar surface 2153 matches the planar surface 115. An extension of the inner planar surface 2153 passes through an axis of the main body 211. In one embodiment, the inner arcuate surface 2153 connects with the inner planar surface 2151 of an adjacent bar-type groove 215. The bar-type grooves 215 are cut by a diamond cutter (not shown). The resin layer 213 is made of Teflon.

The second roll 23 includes a base body 231 and a second resin layer 233 coated on a sidewall of the base body 231. The base body 231 is substantially cylindrical, and is made of metallic materials, such as stainless steel, for example. The second resin layer 233 is made of polymerization resins including fluorine, and defines a plurality of nanometer sized conical holes 235 matching the conical protrusions 131. The conical holes 235 are arranged in a matrix of rows and columns. In one embodiment, the resin layer 213 is made of Teflon.

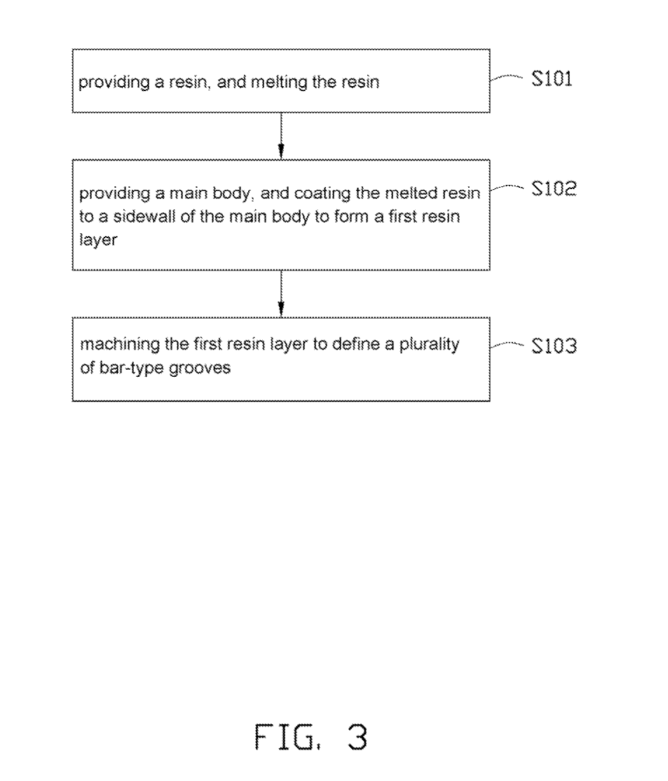

FIG. 3 shows a method of manufacturing the first roll 21.

In step 101, a resin is provided and melted. In one embodiment, the resin is Teflon which has bonding resistance and flexibility characteristics.

In step 102, a main body 211 is provided. The melted resin is coated on a sidewall of the main body 211 to form the first resin layer 213 on the main body 211. In one embodiment, the main body 211 is substantially cylindrical and made of stainless steel.

In step 103, the first resin layer 213 is machined to define a plurality of bar-type grooves 215 parallel to each other. In one embodiment, the bar-type grooves 215 are cut by a diamond cutter (not shown).

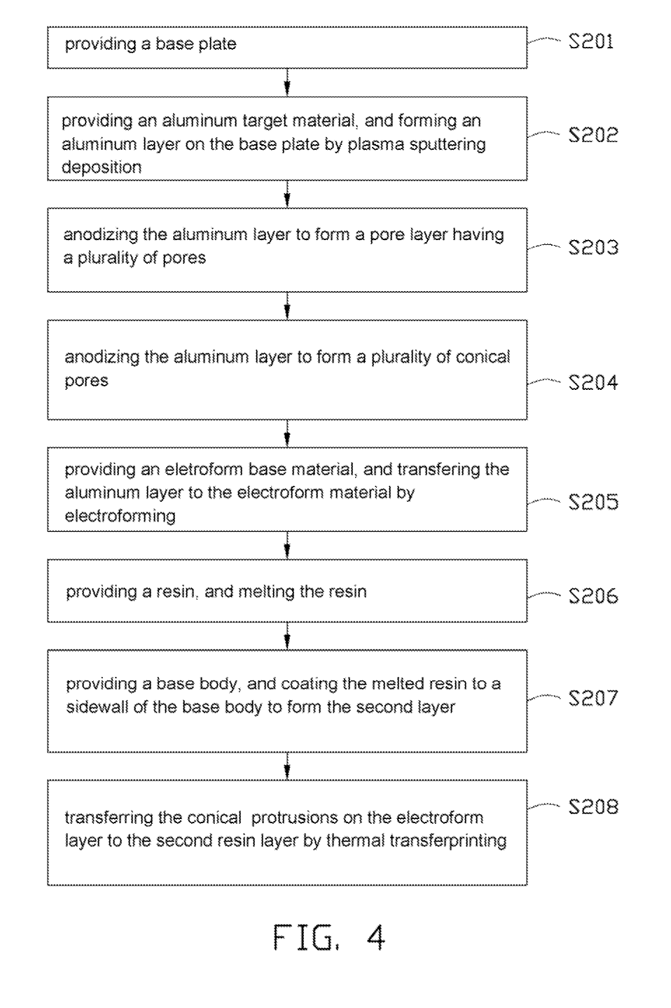

FIG. 4 shows a manufacturing method of the second roll 23.

In step 201, a base plate is provided. The base plate can be a metallic plate or a single crystal silicon plate. In one embodiment, the base plate is a single-crystal silicon plate.

In step 202, an aluminum target material is provided, and an aluminum layer is formed on the base plate by plasma sputtering deposition. In one embodiment, argon gas may be used as a working gas and fed into a chamber evacuated to about 1.3×10-3 Pa. A high voltage direct current is then applied to the base plate and the aluminum target material, to active the argon gas to form plasma which strikes against the surface of the aluminum target material to separate aluminum atoms. Therefore, the aluminum atoms are deposited on the base plate to form the aluminum layer.

In step 203, the aluminum layer is anodized to form a pore layer having a plurality of nanometer sized pores. The anodizing process is processed in an oxalic acid solution. The oxalic acid solution has a mass concentration of about 0.3 mol/L, and is maintained at a temperature of about 17° C. A voltage of about 40V is applied to the oxalic acid solution for forming the plurality of pores on the aluminum layer. Thus the aluminum layer is processed to the pore layer.

In step 204, the aluminum layer is further anodized for pore-enlargement, such that a shape of the nanometer sized conical pores on the aluminum layer is formed. In one embodiment, the aluminum layer with pores is immersed in a phosphorous acid solution for pore-enlargement by anodizing, and the phosphorous acid solution has a mass concentration of about 5% and is maintained at a temperature of about 30° C. The pores are enlarged to nanometer sized conical pores during the anodizing. In one embodiment, the pores are enlarged several times by anodizing in the phosphorous acid solution.

In step 205, an electroform base material is provided. The aluminum layer on the base plate is transferred to the electroform base material by electroforming. In one embodiment, the electroforming base material is nickel. The base plate and the nickel are immersed in a nickel saline solution applied a current density. The base plate has a plurality of conical pores as a cathode, and the nickel material as an anticathode. The nickel material forms an electroform layer having a plurality of nanometer sized conical protrusions corresponding to the conical pores by electroforming. The nickel material with the electroform layer is taken out from the nickel saline solution, and the electroform layer is separated from the nickel material.

In step 206, a resin is provided, and is heated to a melted state. In one embodiment, the resin is Teflon which has bonding resistance and flexibility characteristics.

In step 207, a base body 231 is provided. The melted resin is coated on a sidewall of the base body 231 to form the second resin layer 233. In one embodiment, the main body 231 is substantially cylindrical, and is made of stainless steel.

In step 208, the conical protrusions on the electroform layer are transferred to the second resin layer 233 by thermal transfer printing. The second resin layer 233 forms a plurality of conical holes 235 corresponding to the conical protrusions on the electroform layer.

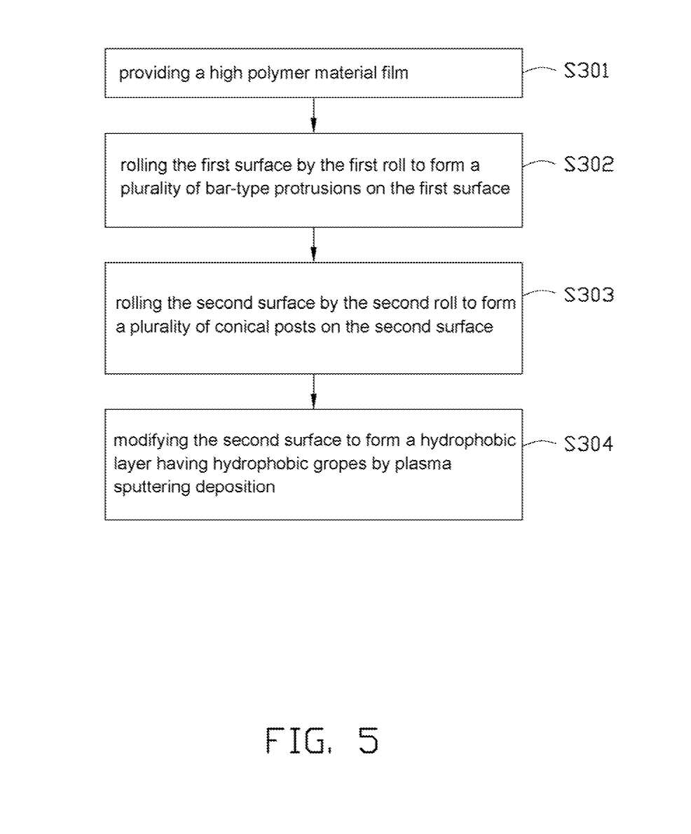

FIG. 5 shows a manufacturing method of the optical film.

In step 301, a high polymer material film is provided. In one embodiment, the high polymer material film is a polyethylene terephthalate film.

In step 302, the first roll 21 rolls on the first surface 11, to enable the first surface 11 to form a plurality of bar-type protrusions 111 corresponding to the bar-type grooves 215. Because the plurality of bar-type grooves 215 are defined on the first roll 21, thus the bar-type protrusions 111 may be formed on the first surface 11 corresponding to the bar-type grooves 215 by rolling the first roll 21 on the first surface 11

In step 303, the second roll 23 rolls on the second surface 13, to enable to the second surface 13 to form a plurality of conical protrusions 131 corresponding to the conical holes 235. Because the plurality of nanometer sized conical holes 235 are defined on the second roll 23, thus the nanometer sized conical protrusions 131 may be formed on the second surface 13 corresponding to the nanometer sized conical holes 235 by rolling the second roll 23 on the second surface 13.

In step 304, the second surface 13 is modified to form a hydrophobic layer having hydrophobic groups. In one embodiment, the second surface has hydrophobic characteristics because the second surface is modified by plasma sputtering deposition using a target material of CF4.

In other embodiments, the second surface 13 of the optical film 100 can be omitted, and the optical film 100 having the first surface 11 can guide the light well to the room when in use.

It is believed that the present embodiments and their advantages will be understood from the foregoing description, and it will be apparent that various changes may be made thereto without departing from the spirit and scope of the embodiments or sacrificing all of its material advantages.

What is claimed is:

1. An optical film, comprising:
a base plate comprising a first surface and a second surface opposite to the first surface;
a plurality of conical protrusions formed on the second surface; and
a plurality of bar-type protrusions arranged on the first surface parallel to each other, wherein each of the bar-type protrusions comprises an arcuate surface and a planar surface connected to the arcuate surface and intersecting with the first surface.

2. The optical film of claim 1, wherein the planar surface is perpendicular to the first surface, and the arcuate surface is a part of a sidewall of a cylinder.

3. The of claim 1, wherein the second surface forms a hydrophobic layer having hydrophobic groups.

4. The optical film of claim 1, wherein the conical protrusions are arranged on the second surface in a matrix of rows and columns.

5. A device for manufacturing optical film, comprising:
a first roller comprising a first resin layer coated on a sidewall thereof, the first resin layer defining a plurality of bar-type grooves arranged side by side, each bar-type groove defining an inner sidewall comprising an inner arcuate surface and an inner planar surface connected to the inner arcuate surface; and
a second roll defining a plurality of conical holes at a sidewall thereof.

6. The device of claim 5, wherein the first roll further comprises a cylindrical main body, the first resin layer is coated on a sidewall of the main body, the second roll further comprises a cylindrical base body, and the second resin layer is coated on a sidewall of the base body.

7. The device of claim 6, wherein an extension of the inner planar surface passes through an axis of the main body, and the inner arcuate surface connects with an inner planar surface of adjacent bar-type groove.

8. The device of claim 5, wherein the conical holes are arranged in a matrix of rows and columns.

9. A method for manufacturing an optical film, comprising following steps:
providing a high polymer material film comprising a first surface and a second surface opposite to the first surface;
providing a first roll comprising a first resin layer coated on a sidewall thereof, the first resin layer defining a plurality of bar-type grooves arranged side by side, each bar-type groove defining an inner sidewall comprising an inner arcuate surface and an inner planar surface connected to the inner arcuate surface;
rolling the first surface by the first roll to form a plurality of bar-type protrusions on the first surface corresponding to the plurality of bar-type grooves;
providing a second roll defining a plurality of conical holes at a sidewall thereof; and
rolling the second surface by the second roll to form a plurality of conical protrusions on the second surface corresponding to the plurality of conical holes.

10. The method of claim 9, further comprising modifying the second surface to form a hydrophobic layer having hydrophobic groups by plasma sputtering deposition.

11. The method of claim 9, wherein the first roll further comprises a cylindrical main body, and the first resin layer is coated on a sidewall of the main body.

12. The method of claim 11, wherein a method of manufacturing the first roll comprises:
providing a resin and melting the resin;
providing a cylindrical main body and coating the melted resin to a sidewall of the main body to form the first resin layer; and
machining the first resin layer to define the plurality of bar-type grooves arranged parallel to each other.

13. The method of claim 9, wherein the second roll further comprises a cylindrical base body, the second resin layer is coated on a sidewall of the base body.

14. The method of claim 13, wherein a method of manufacturing the second roll comprises:
providing a base plate;
providing an aluminum target material and forming an aluminum layer on the base plate by plasma sputtering deposition;
anodizing the aluminum layer to form a pore layer having a plurality of pores;
anodizing the aluminum layer for pore-enlargement to form a plurality of conical pores;
providing an electroform base material and transferring the aluminum layer to the electroform base material by electroforming, thus forming an electroform layer comprising a plurality of conical protrusions corresponding to the plurality of conical pores on the electroform base material;
providing a resin and melting the resin;
providing a cylindrical base body and coating the melted resin to a sidewall of the base body to form the second resin layer;
transferring the conical protrusions on the electroform layer to the second resin layer by thermal transfer printing, thus forming a plurality of conical holes corresponding to the conical protrusions on the second resin layer.

15. The method of claim 9, wherein the high polymer material film is a polyethylene terephthalate film.
